(19) United States
(12) Patent Application Publication
(10) Pub. No.: US 2018/0118192 A1
(43) Pub. Date: May 3, 2018

(54) HYBRID VEHICLE

(71) Applicant: TOYOTA JIDOSHA KABUSHIKI KAISHA, Toyota-shi (JP)

(72) Inventors: Takaya SOMA, Anjo-shi (JP); Kuniaki NIIMI, Toyota-shi (JP)

(73) Assignee: TOYOTA JIDOSHA KABUSHIKI KAISHA, Toyota-shi (JP)

(21) Appl. No.: 15/797,105

(22) Filed: Oct. 30, 2017

(30) Foreign Application Priority Data
Nov. 2, 2016 (JP) 2016-215231

(51) Int. Cl. B60W 20/30; B60W 10/02; B60W 10/06; B60W 10/08; B60W 10/10

(52) U.S. Cl. CPC B60W 20/30; B60W 10/02; B60W 10/06; B60W 10/08; B60W 10/10; Y10S 903/93; B60W 2510/087; B60W 2710/083; B60W 2710/1005; B60Y 2200/92; B60W 2710/088

(57) ABSTRACT

A hybrid vehicle includes an engine, a motor, an inverter, an electric power storage device, a transmission, and an electronic control unit. The electronic control unit is configured to perform control such that the inverter regeneratively drives the motor, when the electrical system temperature is equal to or higher than a predetermined temperature, set an amount of change of a gear ratio to a down-shift side based on an electrical system temperature and regenerative torque of the motor, and set target gear ratio such that the gear ratio changes to the down-shift side by the amount of change.

### INCORPORATION BY REFERENCE

The disclosure of Japanese Patent Application No. 2016-215231 filed on Nov. 2, 2016 including the specification, drawings and abstract is incorporated herein by reference in its entirety.

### BACKGROUND

### 1. Technical Field

The present disclosure relates to a hybrid vehicle, and in particular, relates to a hybrid vehicle including an engine, a motor, an inverter, and a transmission.

### 2. Description of Related Art

In the related art, as a hybrid vehicle, a hybrid vehicle including an engine, a motor, an inverter, and a transmission has been suggested (for example, see Japanese Unexamined Patent Application Publication No. 2006-144843 (JP 2006-144843 A)). The engine or the motor is configured to output power for traveling. The inverter is configured to drive the motor. The transmission is connected between a rotational shaft of the motor and a drive shaft coupled to an axle. In the above-described hybrid vehicle, when a road gradient is equal to or greater than a predetermined gradient, the transmission is down-shifted, thereby suppressing deficiency in torque output to the drive shaft in an ascending gradient.

### SUMMARY

In general, in the above-described hybrid vehicle, in order to suppress an increase in temperature of the motor or the inverter, the higher the temperature of the motor or the inverter, the more largely the drive of the motor is limited. In the hybrid vehicle, basically, at the time of powering, power for traveling is primarily output from the engine, and at the time of regeneration, the motor is regeneratively driven to charge the battery. Accordingly, at the time of regeneration, a load of the motor is likely to become greater than at the time of powering, the temperature of the motor or the inverter increases, and the drive of the motor is likely to be limited. In a case where the drive of the motor is limited at the time of regeneration, the battery cannot be sufficiently charged, and energy efficiency is degraded. For this reason, it is desirable to suppress limitation of the drive of the motor at the time of regeneration.

The present disclosure provides a hybrid vehicle that suppresses limitation of drive of a motor at the time of regeneration.

An aspect of the present disclosure relates to a hybrid vehicle including an engine, a motor, an inverter, an electric power storage device, a transmission, and an electronic control unit. The engine is configured to output power for traveling of the hybrid vehicle. The motor is configured to output power for traveling of the hybrid vehicle. The inverter is configured to drive the motor. The electric power storage device is configured to exchange electric power with the motor through the inverter. The transmission is configured to output power from the motor to a drive shaft coupled to drive wheels of the hybrid vehicle. The transmission is configured to change a gear ratio between the motor and the drive shaft. The electronic control unit is configured to perform a control such that the inverter drives the motor with torque within a range of limit torque based on an electrical system temperature that is a temperature of at least one of the inverter and the motor. The electronic control unit is configured to perform a control such that the transmission makes the gear ratio become a target gear ratio. When the electronic control unit performs a control such that the inverter regeneratively drives the motor and the electrical system temperature is equal to or higher than a predetermined temperature, the electronic control unit is configured to set an amount of change of the gear ratio to a down-shift side based on the electrical system temperature and regenerative torque of the motor, and set the target gear ratio such that the gear ratio changes to the down-shift side by the amount of change of the gear ratio.

According to the aspect of the present disclosure, the electronic control unit is configured to perform control such that the inverter drives the motor with torque within a range of the limit torque based on the electrical system temperature that is the temperature of at least one of the inverter and the motor. The electronic control unit is configured to perform control such that the transmission makes the gear ratio become the target gear ratio. Then, when the electronic control unit performs control such that the inverter regeneratively drives the motor and the electrical system temperature is equal to or higher than the predetermined temperature, the electronic control unit is configured to set the amount of change of the gear ratio to the down-shift side based on the electrical system temperature and the regenerative torque of the motor, and set the target gear ratio such that the gear ratio changes to the down-shift side by the amount of change. In a case where the electrical system temperature is high, the torque of the motor is likely to be limited, and in a case where the regenerative torque is large, the amount of heat generated from the motor or the inverter is large, the electrical system temperature is likely to increase, and the torque of the motor is likely to be limited. Accordingly, the transmission is controlled such that the gear ratio of the transmission is changed from a current gear ratio to the down-shift side by the amount of change based on the electrical system temperature and the regenerative torque of the motor to make the gear ratio become the target gear ratio. With this, the transmission is more properly down-shifted to increase a rotation speed of the motor and to decrease the regenerative torque of the motor, thereby more properly decreasing a current flowing in the motor or the inverter. With this, it is possible to more properly suppress an increase in the electrical system temperature. As a result, it is possible to suppress limitation of the drive of the motor at the time of regeneration.

In the hybrid vehicle according to the aspect of the present disclosure, the electronic control unit may be configured to, when the electrical system temperature is equal to or higher than a limit temperature higher than the predetermined temperature, set the limit torque smaller when the electrical system temperature is high than when the electrical system temperature is low. The electronic control unit may be configured to set the amount of change to be greater when the electrical system temperature is high than when the electrical system temperature is low, and set the amount of change to be greater when the regenerative torque is large than when the regenerative torque is small. That is, the higher the electrical system temperature, the greater the amount of change, and the greater the regenerative torque, the greater the amount of change. With this, since the higher the electrical system temperature and the greater the regenerative torque, the more largely the gear ratio of the transmission is changed to the down-shift side, it is possible to further increase the amount of decrease in the torque of the motor. With this, it is possible to suppress an increase in the electrical system temperature, and to suppress limitation of the drive of the motor.

The hybrid vehicle according to the aspect of the present disclosure may further include a clutch configured to couple an output shaft of the engine and a rotational shaft of the motor. With this, even in a hybrid vehicle of a type in which an output shaft of an engine and a rotational shaft of a motor are connected by a clutch, it is possible to suppress limitation of the drive of the motor.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a configuration diagram showing the outline of the configuration of a hybrid vehicle as an example of the present disclosure;

FIG. 2 is a flowchart showing an example of an in-regeneration gear shift control routine that is executed by an electronic control unit of the example; and

FIG. 3 is an explanatory view showing the relationship of a coolant temperature, a torque command, and a level.

### DETAILED DESCRIPTION OF EMBODIMENTS

Next, a mode for carrying out the present disclosure will be described using an example.

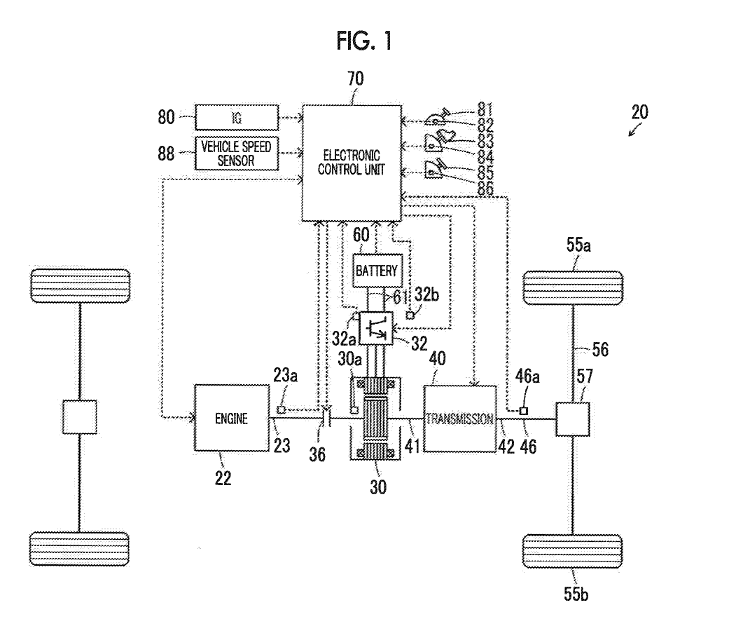

FIG. 1 is a configuration diagram showing the outline of the configuration of a hybrid vehicle 20 as an example of the present disclosure. As shown in the drawing, the hybrid vehicle 20 of the example includes an engine 22, a motor 30, an inverter 32, a clutch 36, an automatic transmission 40, a battery 60, and an electronic control unit 70.

The engine 22 is constituted as an internal combustion engine that outputs power for traveling with gasoline, diesel, or the like as fuel.

The motor 30 is constituted as, for example, a synchronous motor generator. The inverter 32 is connected to the motor 30 and is connected to an electric power line 61. The motor 30 is rotationally driven through switching control of a plurality of switching elements of the inverter 32 by the electronic control unit 70. The clutch 36 is constituted as, for example, a hydraulic drive frictional clutch, and performs connection and disconnection between a crankshaft 23 as an output shaft of the engine 22 and a rotational shaft of the motor 30.

The automatic transmission 40 is constituted as a 10-speed automatic transmission. The automatic transmission 40 has an input shaft 41 connected to the rotational shaft of the motor 30, an output shaft 42 connected to a drive shaft 46 coupled to drive wheels 55a, 55b through an axle 56 and a differential gear 57, a plurality of planetary gears, and a plurality of hydraulic drive frictional engagement elements (clutches and brakes). The automatic transmission 40 forms forward gear stages of first gear to tenth gear or a reverse gear stage by engaging and disengaging the frictional engagement elements to transmit power between the input shaft 41 and the output shaft 42.

The battery 60 is constituted as, for example, a lithium-ion secondary battery, and is connected to the electric power line 61 along with the inverter 32.

Though not shown, the electronic control unit 70 is constituted as a microprocessor centering on a CPU, and includes, in addition to the CPU, a ROM that stores a processing program, a RAM that temporarily stores data, and an input/output port. Signals from various sensors are input to the electronic control unit 70 through the input port. As the signals that are input to the electronic control unit 70, for example, a crank angle θcr from a crank position sensor 23a that detects a rotation position of the crankshaft 23 of the engine 22, a rotation position θm of a rotor of the motor 30 from a rotation position detection sensor (for example, a resolver) 30a that detects the rotation position of the rotor of the motor 30, and a rotation speed Np of the drive shaft 46 from a rotation speed sensor 46a attached to the drive shaft 46 can be exemplified. Furthermore, a voltage Vb of the battery 60 from a voltage sensor attached between terminals of the battery 60, and a current Ib of the battery 60 from a current sensor attached to an output terminal of the battery 60 can be exemplified. In addition, an ignition signal from an ignition switch 80, a shift position SP from a shift position sensor 82 that detects an operation position of a shift lever 81, an accelerator operation amount Acc from an accelerator pedal position sensor 84 that detects a depression amount of an accelerator pedal 83, a brake pedal position BP from a brake pedal position sensor 86 that detects a depression amount of a brake pedal 85, and a vehicle speed V from a vehicle speed sensor 88 can be exemplified. The shift position SP includes a parking position (P position), a reverse position (R position), a neutral position (N position), a forward position (D position), and the like. In addition, as the signals that are input to the electronic control unit 70, an element temperature Tinv from a temperature sensor 32a that detects a temperature of at least one of the switching elements of the inverter 32, and a coolant temperature Twi from a coolant temperature sensor 32b that detects a temperature of coolant cooling the inverter 32 can be exemplified. Various control signals are output from the electronic control unit 70 through the output port. As the signals that are output from the electronic control unit 70, for example, a control signal to the engine 22 can be exemplified. Furthermore, a control signal to the inverter 32, a control signal to the clutch 36, and a control signal to the automatic transmission 40 can be exemplified. The electronic control unit 70 calculates a rotation speed Ne of the engine 22 based on the crank angle θcr of the engine 22 from the crank position sensor 23a. The electronic control unit 70 calculates a rotation speed Nm (a rotation speed Natin of the input shaft 41 of the automatic transmission 40) of the motor 30 based on the rotation position θm of the rotor of the motor 30 from the rotation position detection sensor 30a.

The hybrid vehicle 20 of the example configured as above travels in an electrically powered traveling (EV traveling) mode in which traveling is performed using power from the motor 30 without the operation of the engine 22 in a state in which the clutch 36 is turned off or in a hybrid traveling (HV traveling) mode in which traveling is performed using power from the engine 22 and the motor 30 in a state in which the clutch 36 is turned on.

In the HV traveling mode, a target gear shift stage S* of the automatic transmission 40 is set based on the accelerator operation amount Ace and the vehicle speed V, and the automatic transmission 40 is controlled such that the gear shift stage of the automatic transmission 40 becomes the target gear shift stage S*. Such control is referred to as “normal gear shift control”. Requested torque Tp* of the drive shaft 46 (the output shaft 42 of the automatic transmission 40) is set based on the accelerator operation amount Acc, the vehicle speed V, and the brake pedal position BP, and requested torque Tin* of the input shaft 41 of the automatic transmission 40 is calculated based on the requested torque Tp* of the drive shaft 46 and a gear ratio Gr of the automatic transmission 40. The gear ratio Gr of the automatic transmission 40 is calculated by dividing the rotation speed Nm (the rotation speed Natin of the input shaft 41 of the automatic transmission 40) of the motor 30 by the rotation speed Np of the drive shaft 46, or a value corresponding to a current gear shift stage of the automatic transmission 40 can be used. Then, target torque Te* of the engine 22 is set based on the rotation speed Ne (=the rotation speed Nm of the motor 30) and a fuel consumption operation line of the engine 22. The fuel consumption operation line of the engine 22 is a line that defines the relationship of power Pe, the rotation speed Ne, and torque Te of the engine 22 for efficient operation of the engine 22. In addition, requested torque Tmreq of the motor 30 is set such that the requested torque Tin* is output to the input shaft 41, and a smaller value out of the requested torque Tmreq and limit torque Tlim is set as the torque command Tmin* of the motor 30. The limit torque Tlim is an upper limit value of the torque of the motor 30, is set to a given value when the coolant temperature Twi is equal to or less than a limit threshold Twiref, and in a case where the coolant temperature Twi exceeds the limit threshold Twiref, is set to become smaller when the coolant temperature Twi is high than when the coolant temperature Twi is low, that is, so as to become smaller when the coolant temperature Twi becomes higher. Then, the engine 22 is controlled such that the engine 22 is operated with the target torque Te*, and the switching control of the switching elements of the inverter 32 is performed such that the motor 30 is driven with the torque command Tm*.

In the EV traveling mode, with the same method as in the HV traveling mode, the target gear shift stage S* of the automatic transmission 40 is set, and the automatic transmission 40 is controlled such that the gear shift stage of the automatic transmission 40 becomes the target gear shift stage S*. With the same method as in the HV traveling mode, the requested torque Tp* of the drive shaft 46 is set based on the accelerator operation amount Ace, the vehicle speed V, and the brake pedal position BP. The requested torque Tin* of the input shaft 41 of the automatic transmission 40 is calculated based on the requested torque Tp* of the drive shaft 46 and the gear ratio Gr of the automatic transmission 40. In addition, the requested torque Tmreq of the motor 30 is set such that the requested torque Tin* is output to the input shaft 41, and a value obtained by multiplying the requested torque Tmreq of the motor 30 by a load factor R is set as the torque command Tm* of the motor 30. Then, the operation of the engine 22 is stopped, and the switching control of the switching elements of the inverter 32 is performed such that the motor 30 is driven with the torque command Tm*.

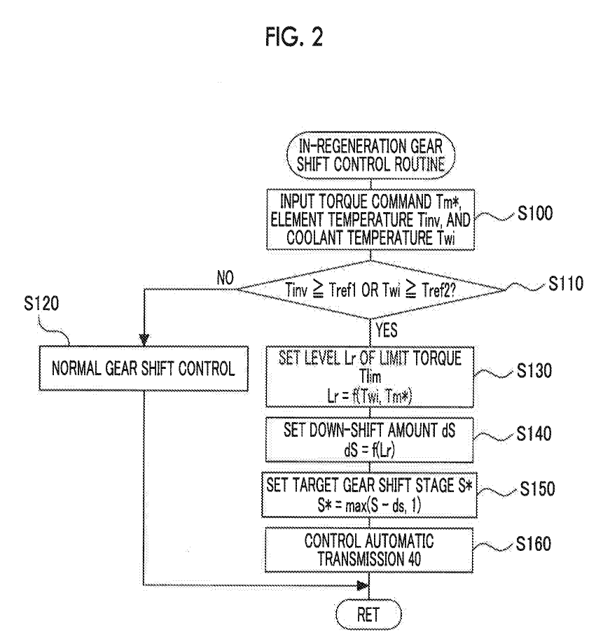

Next, an operation of the hybrid vehicle 20 of the example configured as above, in particular, control of the automatic transmission 40 when the motor 30 is regeneratively controlled during traveling in the D range will be described. FIG. 2 is a flowchart showing an example of an in-regeneration gear shift control routine that is executed by the electronic control unit 70 of the example. The routine is executed when the accelerator pedal 83 is turned off during traveling with the shift position SP being the D position or when the brake pedal 85 is turned on and the torque command Tm* of the motor 30 becomes a negative value (regenerative torque). When the accelerator pedal 83 is turned off or the brake pedal 85 is turned on during traveling, the clutch 36 is turned off to execute fuel cut of the engine 22 or to stop the operation of the engine 22.

In a case where the routine is executed, processing for inputting the torque command Tmin*, the element temperature Tinv, and the coolant temperature Twi is executed (Step S100). For the torque command Tm*, a value set in the control in the HV traveling mode or the EV traveling mode described above is input. For the element temperature Tinv, a value detected by the temperature sensor 32a is input. For the coolant temperature Twi, a value detected by the coolant temperature sensor 32b is input.

Subsequently, determination is made whether or not the input element temperature Tinv is equal to or higher than a determination threshold Tref1 and whether or not the input coolant temperature Twi is equal to or higher than a determination threshold Tref2 (Step S110). The determination threshold Tref1 is a threshold for determining whether or not the temperature of each switching element of the inverter 32 is comparatively high. The determination threshold Tref2 is a threshold for determining whether or not the temperature of the inverter 32 is comparatively high. The determination thresholds Tref1, Tref2 are set as values lower than the limit threshold Twiref.

In the processing of Step S110, when determination is made that the element temperature Tinv is lower than the determination threshold Tref1 and the coolant temperature Twi is lower than the determination threshold Tref2, determination is made that the inverter 32 is not at high temperature, the above-described normal gear shift control is executed (Step S120), and the routine ends.

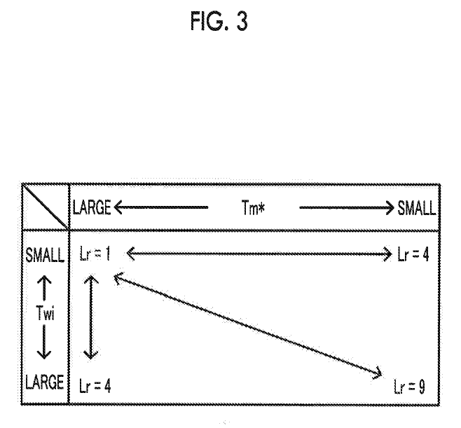

In the processing of Step S110, when determination is made that the element temperature Tinv is equal to or higher than the determination threshold Tref1 and the coolant temperature Twi is equal to or higher than the determination threshold Tref2, determination is made that the temperature of the inverter 32 is comparatively high and the load factor R becomes a value smaller than a value of 1, and the level Lr of the limit torque Tlim is set using the coolant temperature Twi and the torque command Tm* (Step S130). FIG. 3 is an explanatory view showing the relationship of the coolant temperature Twi, the torque command Tm*, and the level Lr. In the example, as shown in the drawing, the level Lr is set in nine stages (level 1 to level 9). The above-described setting is based on constituting the automatic transmission 40 as a 10-speed automatic transmission and associating the level Lr with the down-shift amount dS as described below. In the example, although the level Lr is set in the nine stages, the number of stages to be set can be suitably determined, and for example, the level Lr may be set in three stages. In the example, the level Lr is set to be higher when the coolant temperature Twi is high than when the coolant temperature Twi is low, that is, is set to be higher when the coolant temperature Twi is higher. The level Lr is set to be higher when the torque command Tm* is small (as an absolute value, large) than when the torque command Tm* is large (as an absolute value, small), that is, is set to be higher when the torque command Tm* is smaller (as an absolute value, greater). Setting the level Lr to be higher when the coolant temperature Twi is high than when the coolant temperature Twi is low is based on, when the coolant temperature Twi exceeds the limit threshold Twiref, setting the limit torque Tlim to be smaller when the coolant temperature Twi is high than when the coolant temperature Twi is low. Setting the level Lr to be higher when the torque command Tm* is small (as an absolute value, large) than when the torque command Tm* is large (as an absolute value, small) is based on a current flowing in the inverter 32 being large when the torque command Tm* is small (as an absolute value, large) than when the torque command Tm* is large (as an absolute value, small), the coolant temperature Twi being likely to increase due to heat generated from the inverter 32, and the limit torque Tlim being likely to be small. That is, the reason is because, when the level Lr is higher, the limit torque Tlim is set or is likely to be set to be smaller, and the drive of the motor 30 is likely to be limited.

In a case where the level Lr of the limit torque Tlim is set in this manner, the down-shift amount dS that is an amount of change of a gear shift stage to a down-shift side is set using the set level Lr (Step S140). A greater value out of a value (=S−dS) obtained by subtracting the down-shift amount dS from a current gear shift stage S and a value of 1 is set as the target gear shift stage S* (Step S150). The automatic transmission 40 is controlled such that the gear shift stage of the automatic transmission 40 becomes the target gear shift stage S* (Step S160), and the routine ends. In the processing of Step S140, the down-shift amount dS is set to be greater when the level Lr is large than when the level Lr is small, that is, to be greater when the level Lr is greater. The greater the down-shift amount dS, the smaller the gear shift stage of the automatic transmission 40, and the higher the gear ratio. In a case where the gear ratio becomes high, the requested torque Tin* of the input shaft 41 of the automatic transmission 40 becomes small, and the requested torque Tmreq of the motor 30 becomes small. In a case where the requested torque Tmreq of the motor 30 becomes small, the current flowing in the inverter 32 becomes small and heat generation from the inverter 32 is suppressed. In a case where heat generation from the inverter 32 is suppressed, an increase in the coolant temperature Twi is suppressed, and setting of the limit torque Tlim to be small with the coolant temperature Twi exceeding the limit threshold Twiref is suppressed. Accordingly, in the processing of Step S140, the down-shift amount dS is set to be greater when the level Lr is large than when the level Lr is small, whereby it is possible to suppress limitation of the drive of the motor 30 due to the limit torque Tlim being set to be small. Since such control is executed when the motor 30 is regeneratively controlled, it is possible to suppress deterioration of drivability compared to when the control is executed at the time of powering.

With the hybrid vehicle 20 of the example described above, when the motor 30 is regeneratively driven, and when the element temperature Tinv is equal to or higher than the determination threshold Tref1 and the coolant temperature Twi is equal to or higher than the determination threshold Tref2, the down-shift amount dS is set using the coolant temperature Twi and the torque command Tm*. The target gear shift stage S* is set such that the gear shift stage S is down-shifted by the down-shift amount dS, and the automatic transmission 40 is controlled such that the gear shift stage becomes the target gear shift stage S*, whereby it is possible to suppress limitation of the drive of the motor 30.

In the hybrid vehicle 20 of the example, through the processing of Steps S130 and S140, the level Lr of the limit torque Tlim is set using the coolant temperature Twi and the torque command Tm*, and the down-shift amount dS is set using the level Lr. However, in place of the processing of Steps S130 and S140, the down-shift amount dS may be set using the limit torque Tlim. In this case, the down-shift amount dS may be set to be greater when the limit torque Tlim is small than when the limit torque Tlim is large, that is, the down-shift amount dS may be set to be greater when the limit torque Tlim is smaller.

In the hybrid vehicle 20 of the example, through the processing of Step S110, determination is made whether or not the element temperature Tinv is equal to or higher than the determination threshold Tref1 and whether or not the coolant temperature Twi is equal to or higher than the determination threshold Tref2. However, determination may be exclusively made whether or not the element temperature Tinv is equal to or higher than the determination threshold Tref1, or determination may be exclusively made whether or not the coolant temperature Twi is equal to or higher than the determination threshold Tref2. In place of the element temperature Tinv or the coolant temperature Twi, the temperature of the motor 30 may be used.

In the hybrid vehicle 20 of the example, with the automatic transmission 40 as a stepped transmission, the down-shift amount dS that is the amount of change of the gear shift stage to the down-shift side is set and the target gear shift stage S* of the automatic transmission 40 is set through the processing of Steps S140 and S150. However, when the automatic transmission 40 is a continuously variable transmission, with the down-shift amount dS as an amount of change of a gear ratio to a down-shift side, the automatic transmission 40 may be controlled with a gear ratio when changing the current gear ratio of the automatic transmission 40 to the down-shift side by the down-shift amount dS as a target gear ratio.

In the hybrid vehicle 20 of the example, the limit torque Tlim is set to a given value when the coolant temperature Twi is equal to or lower than the limit threshold Twiref, and in a case where the coolant temperature Twi exceeds the limit threshold Twiref, is set to be smaller when the coolant temperature Twi is high than when the coolant temperature Twi is low. However, the limit torque Tlim may be set to be smaller when the coolant temperature Twi is high than when the coolant temperature Twi is low, regardless of whether or not the coolant temperature Twi exceeds the limit threshold Twiref.

In the hybrid vehicle 20 of the example, although the 10-speed transmission is used as the automatic transmission 40, a four-speed, six-speed, eight-speed, or the like transmission may be used.

Although the hybrid vehicle 20 of the example includes the battery 60, since an electric power storage device that stores electric charge may be provided, for example, a capacitor may be provided in place of the battery 60.

In the example, a case where the present disclosure is applied to the hybrid vehicle including the engine 22, the motor 30, the clutch 36, and the automatic transmission 40 has been illustrated. However, the present disclosure may be applied to any configuration as long as a hybrid vehicle includes an engine configured to output power for traveling, a motor configured to output power for traveling, a battery, and a transmission. In general, in such a hybrid vehicle, since traveling is performed primarily with power from the engine 22 at the time of powering, and the motor is regeneratively driven at the time of regeneration, the present disclosure is suitably applied to such a hybrid vehicle. The present disclosure may be applied to a configuration in which the motor 30 is connected to the drive shaft 46 through the automatic transmission 40 and the engine 22 and a second motor are connected to the drive shaft 46 through the planetary gear.

The correspondence relationship between the primary components of the example and the primary components of the present disclosure described in SUMMARY will be described. In the example, the engine 22 corresponds to an “engine”, the motor 30 corresponds to a “motor”, the inverter 32 corresponds to an “inverter”, the automatic transmission 40 corresponds to a “transmission”, and the electronic control unit 70 corresponds to an “electronic control unit”.

The correspondence relationship between the primary components of the example and the primary components of the present disclosure described in SUMMARY should not be considered to limit the components of the present disclosure described in SUMMARY since the example is merely illustrative to specifically describe the mode for carrying out the present disclosure described in SUMMARY. That is, the present disclosure described in SUMMARY should be interpreted based on the description in SUMMARY, and the example is merely a specific example of the present disclosure described in SUMMARY.

Although the mode for carrying out the present disclosure has been described above in connection with the example, the present disclosure is not limited to the example, and can of course be carried out in various forms without departing from the spirit and scope of the present disclosure.

The present disclosure is usable in a manufacturing industry of a hybrid vehicle.

What is claimed is:

1. A hybrid vehicle comprising:
an engine configured to output power for traveling of the hybrid vehicle;
a motor configured to output power for traveling of the hybrid vehicle;
an inverter configured to drive the motor;
an electric power storage device configured to exchange electric power with the motor through the inverter;
a transmission configured to output power from the motor to a drive shaft coupled to drive wheels of the hybrid vehicle, the transmission being configured to change a gear ratio between the motor and the drive shaft; and
an electronic control unit configured to:
perform a control such that the inverter drives the motor with torque within a range of limit torque based on an electrical system temperature that is a temperature of at least one of the inverter and the motor;
perform a control such that the transmission makes the gear ratio become a target gear ratio; and
when the electronic control unit performs a control such that the inverter regeneratively drives the motor and the electrical system temperature is equal to or higher than a predetermined temperature, set an amount of change of the gear ratio to a down-shift side based on the electrical system temperature and regenerative torque of the motor, and set the target gear ratio such that the gear ratio changes to the down-shift side by the amount of change of the gear ratio.

2. The hybrid vehicle according to claim 1, wherein:
the electronic control unit is configured to, when the electrical system temperature is equal to or higher than a limit temperature higher than the predetermined temperature, set the limit torque smaller when the electrical system temperature is high than when the electrical system temperature is low; and
the electronic control unit is configured to set the amount of change to be greater when the electrical system temperature is high than when the electrical system temperature is low, and set the amount of change to be greater when the regenerative torque is large than when the regenerative torque is small.

3. The hybrid vehicle according to claim 1, further comprising a clutch configured to couple an output shaft of the engine and a rotational shaft of the motor.
